(19) United States
(12) Patent Application Publication
(10) Pub. No.: US 2015/0356633 A1
(43) Pub. Date: Dec. 10, 2015

(54) ADJUSTING QOS LEVELS FOR ADVERTISEMENTS BASED ON USER ANALYTICS

(71) Applicant: Verizon Patent and Licensing Inc., Arlington, VA (US)

(72) Inventors: Deepak KAKADIA, Antioch, CA (US); Lalit R. KOTECHA, San Ramon, CA (US); Kent W. HUGHES, Oakland, CA (US); Sagiv DRAZNIN, Walnut Creek, CA (US)

(73) Assignee: Verizon Patent and Licensing Inc., Arlington, VA (US)

(21) Appl. No.: 14/299,526

(22) Filed: Jun. 9, 2014

(51) Int. Cl. G06Q 30/02

(52) U.S. Cl. CPC G06Q 30/0277; G06Q 30/0269; G06Q 30/0246; G06Q 30/0273

(57) ABSTRACT

A device may be configured to store advertisement control information for an advertisement. The advertisement control information may indicate a target demographic for the advertisement. The device may receive the advertisement to be provided to a user device via an operator network. The device may receive user information that indicates a demographic of a user of the user device. The device may determine a quality of service level with which to provide the advertisement to the user device. The quality of service level may be determined based on the target demographic and the demographic of the user. The device may provide the advertisement to the user device, via the operator network, at the determined quality of service level.

### BACKGROUND

An operator network (e.g., a mobile network, a wireless network, etc.) may deliver over-the-top (OTT) traffic to user devices. For example, the operator network may allow a user device to access a website having video, audio, or other media. The OTT traffic may be used to provide advertisements to users of user devices, thereby generating revenue for an owner of the website.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for preparing to provide advertisements at adjusted quality of service (QoS) levels;

FIG. 5 is a flow chart of an example process for providing advertisements at adjusted QoS levels; and

FIGS. 6A-6C are diagrams of an example implementation relating to the example processes shown in FIGS. 4 and 5.

### DETAILED DESCRIPTION OF PREFERRED EMBODIMENTS

The following detailed description of example implementations refers to the accompanying drawings. The same reference numbers in different drawings may identify the same or similar elements.

Adding advertisements to websites or other types of content may generate revenue for the owner of the website. Moreover, these advertisements may increase the amount of traffic transported via an operator network. However, the operator of the operator network may not be compensated for this increase in traffic or receive any revenue from the advertisements being transported via the operator network.

Accordingly, the operator of the operator network may add advertisements to the content being transported via the operator network to generate revenue. Moreover, the operator network may have access to information about a user of the user device that may be used to select advertisements that target that user. Furthermore, the operator of the operator network may be in a unique position to control a QoS level used to provide the content and/or the advertisements to the user device. Thus, the operator network may not only select an advertisement that targets the user, but the operator network may also adjust a QoS level of the advertisement to further target the user.

Implementations described herein may adjust a QoS level of an advertisement provided to a user device based on user analytics. For example, a QoS level of an advertisement provided to a user device may be adjusted based on a demographic of a user of the user device and a target demographic for the advertisement. Thus, in some implementations, advertisements may be effectively provided to a target audience.

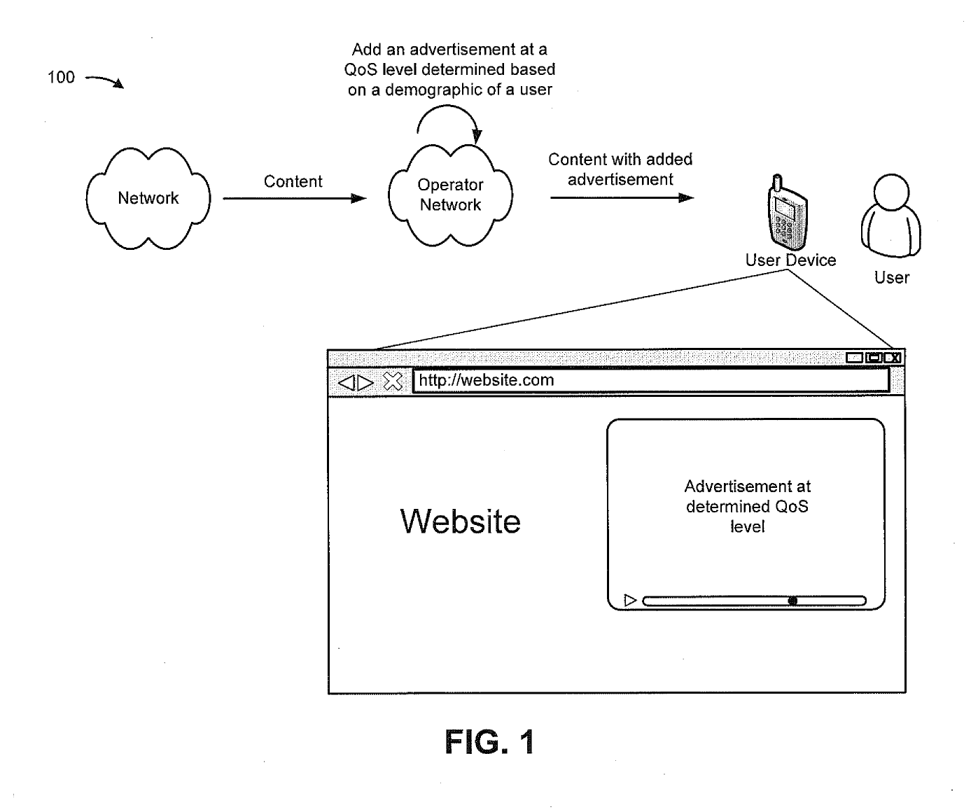

FIG. 1 is a diagram of an overview of an example implementation 100 described herein. In FIG. 1, assume a user of a user device requests access to content (e.g., a website) on a network (e.g., the Internet) via an operator network. As shown in FIG. 1, the content may be provided to the operator network to be wirelessly sent to the user device. The operator network may receive the content from the network.

Further, assume the operator network stores user information about the user of the user device. Also, assume the operator network stores advertisement control information indicating a target demographic for an advertisement (e.g., an age of a user, a gender of a user, a hobby of a user, etc.). The advertisement control information may indicate that an advertiser will pay more when a user in the target demographic clicks on the advertisement than when a user outside of a target demographic clicks on the advertisement. Additionally, or alternatively, the advertisement control information may indicate that the advertiser is willing to pay for simply providing an advertisement at an adjusted QoS level.

The operator network may add an advertisement to the content and determine a QoS level for providing the advertisement based on the user information and the advertisement control information. For example, if the user is included in a target demographic for the advertisement, the operator network may increase the QoS level of the advertisement relative to a QoS level of the content and/or a QoS level with which the advertisement would have otherwise been provided. In some implementations, the operator network may increase the QoS level to receive payment from the advertiser for providing the advertisement at an increased QoS level. Additionally, or alternatively, the operator network may increase the QoS level to make the advertisement more appealing to a user and to increase the likelihood that the user will click on the advertisement, thereby generating revenue for the operator of the operator network. On the other hand, if the user is not included in the target demographic for the advertisement, the operator network may determine that the potential revenue from the user clicking on the advertisement does not outweigh the network cost of providing the advertisement at a higher QoS level. Thus, the operator network may lower the QoS level or keep the QoS level the same as a QoS level of the content and/or a QoS level with which the advertisement would have otherwise been provided.

The operator network may provide the content with the added advertisement, at the determined QoS level, to the user device. The user device may receive the content and the advertisement and present the content and the advertisement to the user.

In this way, an advertisement may be presented to a user device using a QoS level determined by the operator network based on a demographic of the user or other user analytics.

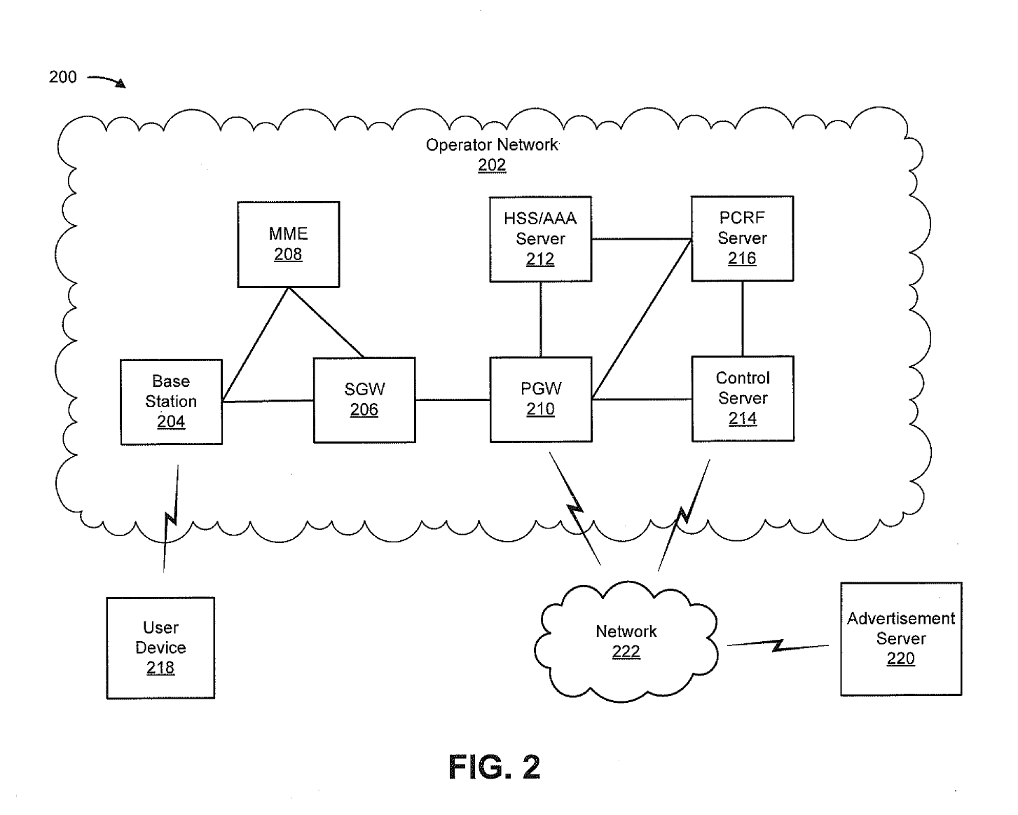

FIG. 2 is a diagram of an example environment 200 in which systems and/or methods described herein may be implemented. As shown in FIG. 2, environment 200 may include an operator network 202. Operator network 202 may include a base station 204, a serving gateway 206 (hereinafter referred to as “SGW 206”), a mobility management entity device 208 (hereinafter referred to as “MME 208”), a packet data network (PDN) gateway 210 (hereinafter referred to as “PGW 210”), a home subscriber server/authentication, authorization, accounting server 212 (hereinafter referred to as “HSS/AAA server 212”), a control server 214, and/or a policy and charging rules function server 216 (hereinafter referred to as “PCRF server 216”). Environment 200 may also include a user device 218, an advertisement server 220, and/or a network 222. Devices of environment 200 may interconnect via wired connections, wireless connections, or a combination of wired and wireless connections.

Operator network 202 may include an evolved packet system (EPS) that includes a long term evolution (LTE) network and/or an evolved packet core (EPC) that operate based on a third generation partnership project (3GPP) wireless communication standard. The LTE network may be a radio access network (RAN) that includes one or more base stations 204, such as eNodeBs (eNBs), via which user device 218 communicates with the EPC. The EPC may include SGW 206, MME 208, and/or PGW 210 that enables user device 218 to communicate with network 222, HSS/AAA server 212, and/or PCRF server 216 and may manage certain information and services, such as authentication, session initiation, account information, and/or a user profile, associated with user device 218. The LTE network may include multiple base stations 204, and the EPC may include multiple SGWs 206, MMEs 208, and/or PGWs 210. Additionally, or alternatively, operator network 202 may include a cellular network, a public land mobile network (PLMN), a second generation (2G) network, a third generation (3G) network, a fourth generation (4G) network, a fifth generation (5G) network, and/or another network.

Base station 204 may include one or more network devices that receive, process, and/or transmit traffic, such as audio, video, text, and/or other data, destined for and/or received from user device 218. In an example implementation, base station 204 may be an eNB device and may be part of the LTE network. Base station 204 may receive traffic from and/or send traffic to network 222 via SGW 206 and PGW 210. Base station 204 may send traffic to and/or receive traffic from user device 218 via an air interface. One or more of base stations 204 may be associated with a RAN, such as the LTE network.

SGW 206 may include one or more network devices, or other types of computation or communication devices, that gather, process, search, store, and/or provide information in a manner described herein. SGW 206 may include one or more data processing and/or traffic transfer devices, such as a gateway, a router, a modem, a switch, a firewall, a network interface card (NIC), a hub, a bridge, a proxy server, an optical add-drop multiplexer (OADM), or some other type of device that processes and/or transfers traffic. SGW 206 may, for example, aggregate traffic received from one or more base stations 204 and may send the aggregated traffic to network 222 via PGW 210. In some implementations, SGW 206 may route and forward data, may act as a mobility anchor for a user plane during inter-base station handovers, and may act as an anchor for mobility between LTE and other 3GPP technologies.

MME 208 may include one or more computation or communication devices that gather, process, search, store, and/or provide information in a manner described herein. For example, MME 208 may perform operations associated with a handoff to and/or from the EPS. MME 208 may perform operations to register user device 218 with the EPS, to handoff user device 218 from the EPS to another network, to handoff user device 218 from the other network to the EPS, and/or to perform other operations. MME 208 may perform policing operations for traffic destined for and/or received from user device 218.

PGW 210 may include one or more network devices that gather, process, search, store, and/or provide information in a manner described herein. PGW 210 may include one or more data processing and/or traffic transfer devices, such as a gateway, a router, a modem, a switch, a firewall, a NIC, a hub, a bridge, a proxy server, an OADM, or some other type of device that processes and/or transfers traffic. PGW 210 may, for example, provide connectivity of user device 218 to external packet data networks, such as network 222, by being a traffic exit/entry point for user device 218. PGW 210 may perform policy enforcement, packet filtering, charging support, lawful intercept, and packet screening. PGW 210 may also act as an anchor for mobility between 3GPP and non-3GPP technologies. PGW 210 may authenticate user device 218 (e.g., via interaction with HSS/AAA server 212).

HSS/AAA server 212 may include one or more server devices, or other types of computation or communication devices, that gather, process, search, store, and/or provide information in a manner described herein. For example, HSS/AAA server 212 may manage, update, and/or store, in a memory associated with HSS/AAA server 212, profile information associated with user device 218 that identifies applications and/or services that are permitted for and/or accessible by user device 218, bandwidth or data rate thresholds associated with the applications or services, information associated with a user of user device 218 (e.g., a username, a password, a personal identification number (PIN), etc.), a data plan, rate information, minutes allowed, and/or other information. Additionally, or alternatively, HSS/AAA server 212 may include a device that performs authentication, authorization, and/or accounting (AAA) operations associated with a communication session with user device 218. With regard to the authentication operation, HSS/AAA server 212 may verify a device's (e.g., user device 218) specific digital identity provided via an identifier (e.g., a password, a digital certificate, a phone number, etc.) associated with the device. With regard to the authorization function, HSS/AAA server 212 may grant or refuse privileges to a device (e.g., user device 218) for accessing specific services (e.g., IP address filtering, address assignment, route assignment, QoS, etc.). With regard to the accounting operation, HSS/AAA server 212 may track consumption of network resources (e.g., by user device 218) and may use this information for management, planning, billing, etc.

Control server 214 may include one or more devices capable of storing, processing, and/or routing information. In some implementations, control server 214 may include a communication interface that allows control server 214 to receive information from and/or transmit information to other devices in environment 200. In some implementations, control server 214 may include an advertisement management function, and be configured to determine an advertisement to add to content and determine a QoS level at which the advertisement should be provided to user device 218. Additionally, or alternatively, control server 214 may include a content parser function that adds the advertisement, at the determined QoS level, to the content provided to user device 218.

PCRF server 216 may perform operations that enforce EPS policies associated with a communication session with user device 218. For example, PCRF server 216 may dynamically provide real-time bandwidth allocations and/or controls (e.g., associated with a particular access point name (APN)) associated with particular applications, network accesses, and/or services provided to user device 218 during a communication session. PCRF server 216 may also dynamically provide a real-time signal flow policy to adapt to changing conditions within the network and/or to manage traffic flow during the communication session.

User device 218 may include a device capable of receiving, processing, and providing information. For example, user device 218 may include a mobile phone (e.g., a smart phone, a radiotelephone, etc.), a computing device (e.g., a laptop computer, a tablet computer, a handheld computer, a gaming device, etc.), or a similar device. In some implementations, user device 218 may include a communication interface that allows user device 218 to receive information from and/or transmit information to another device in environment 200.

Advertisement server 220 may include one or more devices capable of storing, processing, and/or routing information. In some implementations, advertisement server 220 may include a communication interface that allows advertisement server 220 to receive information from and/or transmit information to other devices in environment 200. Advertisement server 220 may be operated by an advertiser and configured to send advertisement control information and/or an advertisement (to be added to content) to control server 214.

Network 222 may include one or more wired and/or wireless networks. For example, network 222 may include a cellular network (e.g., an LTE network, a 3G network, a code division multiple access (CDMA) network, etc.), a public land mobile network (PLMN), a wireless local area network (e.g., a Wi-Fi network), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or another type of network.

The number and arrangement of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

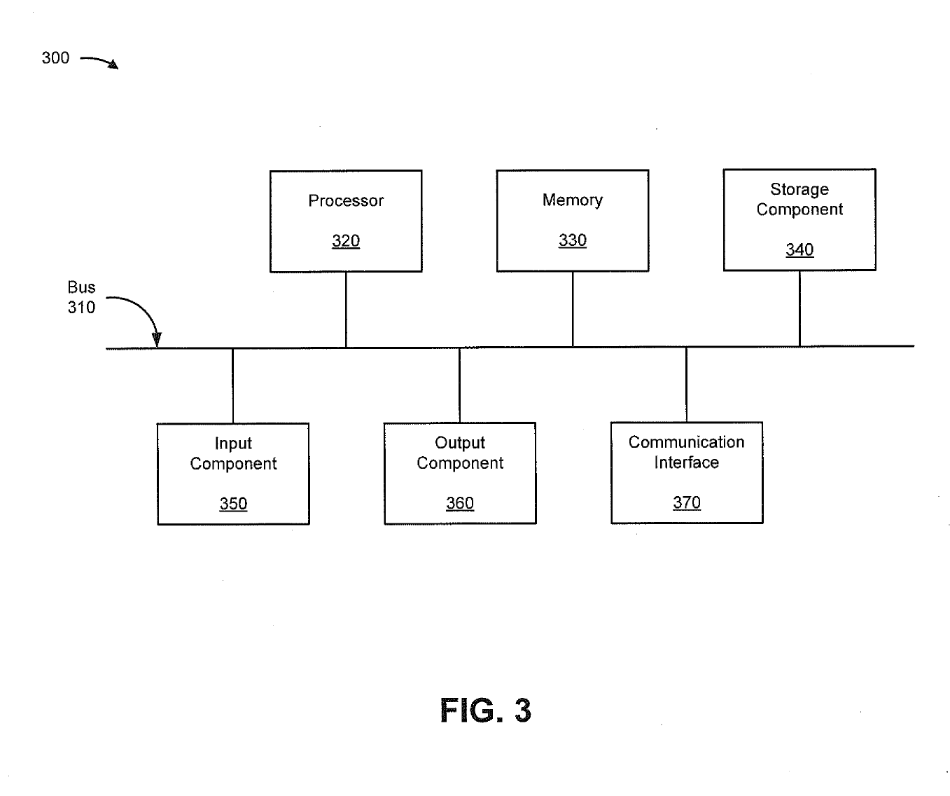

FIG. 3 is a diagram of example components of a device 300. Device 300 may correspond to base station 204, SGW 206, MME 208, PGW 210, HSS/AAA server 212, control server 214, PCRF server 216, user device 218, and/or advertisement server 220. In some implementations, base station 204, SGW 206, MME 208, PGW 210, HSS/AAA server 212, control server 214, PCRF server 216, user device 218, and/or advertisement server 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

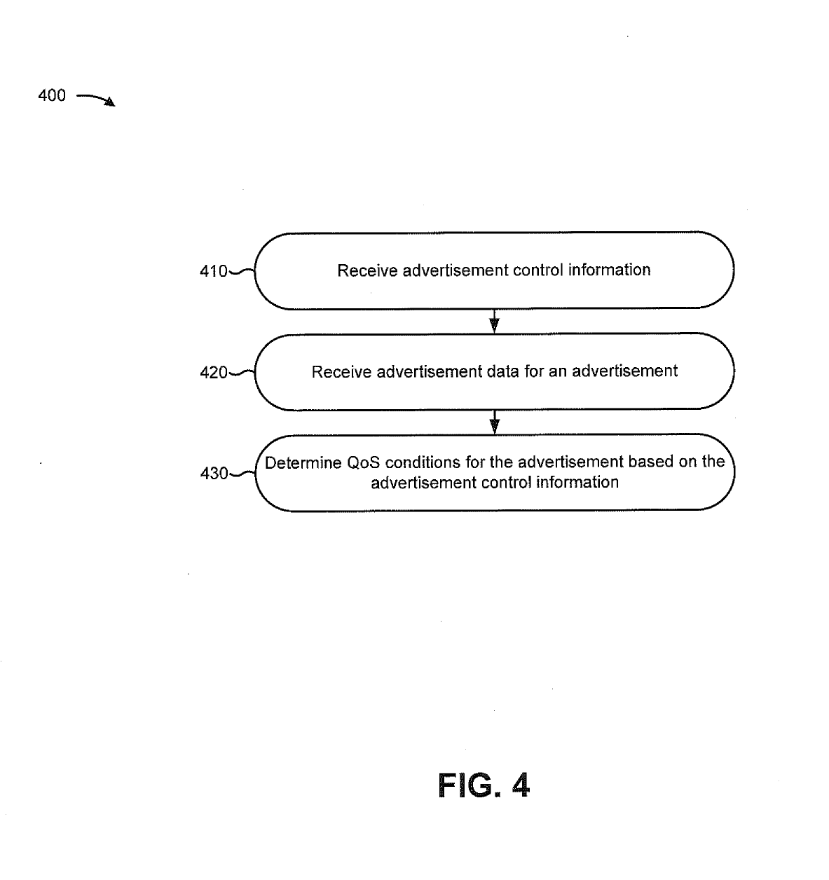

FIG. 4 is a flow chart of an example process 400 for preparing to provide advertisements at adjusted QoS levels. In some implementations, one or more process blocks of FIG. 4 may be performed by control server 214. Additionally, or alternatively, one or more process blocks of FIG. 4 may be performed by another device or a group of devices separate from or including control server 214, such as base station 204, SGW 206, MME 208, PGW 210, HSS/AAA server 212, PCRF server 216, user device 218, and/or advertisement server 220.

As shown in FIG. 4, process 400 may include receiving advertisement control information (block 410). For example, control server 214 may receive the advertisement control information from advertisement server 220.

An advertiser that operates advertisement server 220 may have an agreement with an operator of operator network 202 to add advertisements to content provided to user devices 218 via operator network 202. Advertisement server 220 may send advertisement control information to control server 214 that indicates details of this agreement.

In some implementations, the advertisement control information may include target demographic information that indicates one or more user demographics that are targeted by an advertisement. For example, the target demographic information may indicate a gender, an age, a height, a race, an ethnicity, a religion, a citizenship, a geographic location, an education level, and/or any other demographic information on a targeted user. Additionally, or alternatively, the target demographic information may indicate a habit of a user, an interest of a user, a possession owned by a user, a health of a user, and/or any other kind of user analytics information.

Additionally, or alternatively, the advertisement control information may include target content information that indicates one or more pieces of content to which the advertisement may be added. For example, the target content information may indicate a particular website and/or a kind of website (e.g., a website associated with a particular topic).

Additionally, or alternatively, the advertisement control information may include payment information that indicates an amount the advertiser will pay the operator of operator network 202 for adding the advertisement to the content. In some implementations, the payment information may indicate a cost per click. In other words, the payment information may indicate an amount of compensation the advertiser will pay the operator of operator network 202 each time a user clicks on the advertisement and/or engages with the advertisement. The term “clicks” or the like as used herein may include any kind of selection of an advertisement and is not limited to mouse click. Additionally, or alternatively, the payment information may indicate a QoS cost. In other words, the payment information may indicate an amount of compensation the advertiser will pay the operator network 202 for providing the advertisement at a QoS level higher than a QoS level of the content to which the advertisement is added. In some implementations, the payment information may indicate a QoS cost that varies depending on an excess capacity of bandwidth in operator network 202. For example, the advertiser may pay different amounts to provide the advertisement with an increased QoS for different amounts of excess capacity of bandwidth.

In some implementations, the target demographic information, the target content information, and the payment information may be associated with one another. For example, the advertisement control information may indicate a cost per click and/or a QoS cost for a particular user demographic and/or a particular content. For instance, the payment information may indicate a first cost per click for a user in a first user demographic and a second cost per click for a user in a second user demographic. Likewise, the payment information may indicate a first QoS cost for adding the advertisement to a first kind of content and a second QoS cost for adding the advertisement to a second kind of content.

In some implementations, the advertisement control information may indicate one or more advertisements to be added to content.

Control server 214 may receive the advertisement control information sent from one or more advertisement servers 220. Additionally, or alternatively, control server 214 may receive the advertisement control information from a device other than advertisement server 220 and/or control server 214 may generate all or part of the advertisement control information. Control server 214 may store the advertisement control information in a memory included in or accessible by control server 214.

As further shown in FIG. 4, process 400 may include receiving advertisement data for an advertisement (block 420). For example, control server 214 may receive the advertisement data for the advertisement from advertisement server 220.

In some implementations, advertisement server 220 may send the advertisement data to control server 214. Control server 214 may receive the advertisement data and store the advertisement data in a memory included in or accessible by control server 214. Additionally, or alternatively, control server 214 may send a request to advertisement server 220 to provide the advertisement data in real time when control server 214 is ready to add the advertisement data to the content. Advertisement server 220 may send the advertisement data to control server 214 in real time based on the request and control server 214 may receive the advertisement data.

The advertisement data may include multimedia data (e.g., image data, video data, audio data, etc.) used to present an advertisement to a user and/or a hyperlink that points user device 218 to a particular location (e.g., a webpage, a document, etc.) associated with the advertisement.

As further shown in FIG. 4, process 400 may include determining QoS conditions for the advertisement based on the advertisement control information (block 430). For example, control server 214 may determine the QoS conditions. The QoS conditions may indicate conditions for increasing a QoS level of an advertisement from a QoS level of content to which the advertisement is to be added. A QoS level may correspond to a particular overall performance of a connection and/or particular aspects of a connection, such as a service response time, a packet loss, a signal-to-noise ratio, a frequency response, a loudness level, etc.

In some implementations, an operator of operator network 202 may be compensated for providing advertisements to a user based on a cost per click method of payment. In other words, an advertiser may compensate the operator of operator network 202 each time a user clicks on an advertisement. Accordingly, the operator of operator network 202 may increase the QoS level of an advertisement to attract a user's attention to the advertisement and increase the likelihood the user will click on the advertisement. In such a case, increasing the QoS level may result in potential compensation. Additionally, or alternatively, an advertiser may compensate the operator of operator network 202 based on a QoS cost. In other words, the advertiser may compensate the operator of operator network 202 for providing advertisements to a user at an increased QoS level, regardless of whether the user clicks on the advertisement. Accordingly, the operator of operator network 202 may increase the QoS level of an advertisement to receive compensation simply for providing the advertisement to a user at the adjusted QoS level. In such a case, increasing the QoS level may result in actual compensation.

However, increasing the QoS level of an advertisement may increase the bandwidth used to provide the advertisement. Accordingly, control server 214 may generate QoS conditions for increasing the QoS level of an advertisement based on an excess capacity of bandwidth and the payment information included in the advertisement control information. In other words, the QoS conditions may be a way of balancing a supply of bandwidth with a demand for providing advertisements.

In some implementations, a QoS condition may associate an excess capacity of bandwidth with a threshold cost per click and/or a threshold QoS cost. For example, when a first amount of bandwidth is available, advertisements associated with a first threshold cost per click and/or a first threshold QoS cost may have a QoS level increased. Likewise, when a second amount of bandwidth if available, advertisements associated with a second threshold cost per click and/or a second threshold QoS cost may have a QoS level increased.

In some implementations, the excess capacity of bandwidth and the threshold cost per click and/or the threshold QoS cost may be inversely proportional. In other words, as the excess capacity of broadband increases, the threshold cost per click and/or the threshold QoS cost may decrease. In some implementations, a threshold cost per click associated with an excess capacity of bandwidth may be higher than a threshold QoS cost for the same excess capacity of bandwidth because increasing the QoS level for a cost per click advertisement may result in potential compensation while increasing the QoS level for a QoS cost advertisement may result in actual compensation. On the other hand, a threshold cost per click associated with an excess capacity of bandwidth may be lower than or equal to a threshold QoS cost for the same excess capacity of bandwidth.

In some implementations, the QoS conditions may be based on a time, a day, and/or month. For example, certain times, days, and/or months may be known to be high or low traffic times. Accordingly, a QoS condition may associate a time, a day, and/or a month with a threshold cost per click and/or a threshold QoS cost.

Moreover, the QoS conditions may associate a threshold cost for each of multiple QoS levels for given amounts of excess capacity of bandwidth.

Control server 214 may store information identifying the QoS conditions in a memory included in or accessible by control server 214.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

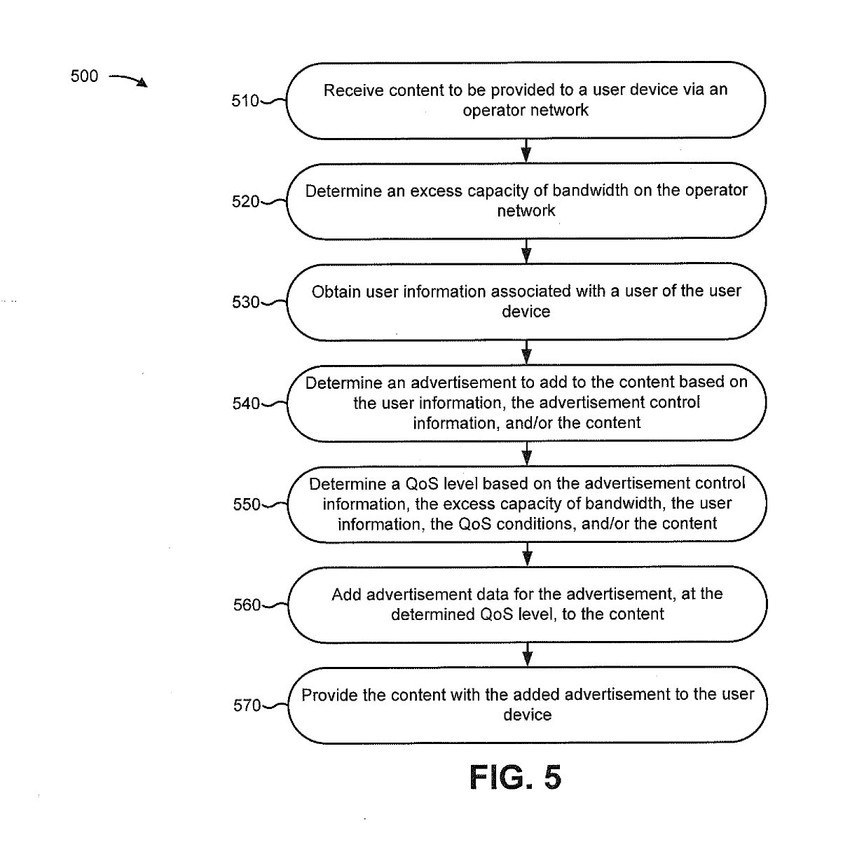

FIG. 5 is a flow chart of an example process 500 for providing advertisements at adjusted QoS levels. In some implementations, one or more process blocks of FIG. 5 may be performed by control server 214. Additionally, or alternatively, one or more process blocks of FIG. 5 may be performed by another device or a group of devices separate from or including control server 214, such as base station 204, SGW 206, MME 208, PGW 210, HSS/AAA server 212, PCRF server 216, user device 218, and/or advertisement server 220.

As shown in FIG. 5, process 500 may include receiving content to be provided to user device 218 via operator network 202 (block 510). For example, control server 214 may receive the content. In some implementations, receiving the content may include receiving a hyperlink to the content.

In some implementations, user device 218 may send a request for content (e.g., a website, a document, etc.) to network 222 via base station 204, SGW 206, and PGW 210. Network 222 may receive the request and route the request to an appropriate destination. Network 222 may receive the content based on the request and provide the content to PGW 210 to be sent to user device 218.

PGW 210 may route the content through control server 214 to add an advertisement to the content before sending the content to user device 218.

As further shown in FIG. 5, process 500 may include determining an excess capacity of bandwidth on operator network 202 (block 520). For example, control server 214 may determine the excess capacity of bandwidth.

In some implementations, one or more devices of operator network 202 (e.g., base station 204 and/or SGW 206) may detect an excess capacity of bandwidth available to user device 218. For example, the one or more devices of operator network 202 may calculate the excess capacity of bandwidth based on an amount of bandwidth currently being used and an amount of bandwidth available for use. The one or more devices of operator network 202 may send information indicating the excess capacity of bandwidth to control server 214. Control server 214 may receive the information indicating the excess capacity of bandwidth.

As further shown in FIG. 5, process 500 may include obtaining user information associated with a user of user device 218 (block 530). For example, control server 214 may obtain the user information.

HSS/AAA server 212 and/or another device included in operator network 202 may store a user data structure including user information associated with each user device 218 authorized to use operator network 202. In some implementations, operator network 202 may obtain access to certain types of user information based on a user's interaction with operator network 202. The user information may include information about a user of user device 218. For example, the user information may indicate a gender, an age, a height, a race, an ethnicity, a religion, a citizenship, a geographic location, an education level, and/or other demographic information of a user. Additionally, or alternatively, the user information may indicate a habit of a user, an interest of a user, a possession owned by a user, a health of a user, and/or any other kind of user analytics information.

Control server 214 may query the user data structure using a user device identifier (e.g., a phone number, an IP address, an international mobile subscriber identity (IMSI), an international mobile station equipment identify (IMEI), a mobile equipment identifier (MEID), etc.) that uniquely identifies the user device 218 to which the content is to be provided. HSS/AAA server 212 and/or the other device that stores the user data structure may send user information associated with the user device identifier for user device 218 to control server 214 based on the query. Control server 214 may receive the user information.

As further shown in FIG. 5, process 500 may include determining an advertisement to add to the content based on the user information, the advertisement control information, and/or the content (block 540). For example, control server 214 may determine an advertisement to add to the content.

In some implementations, control server 214 may determine an advertisement to add to the content based on a demographic of the user (e.g., a gender, a race, a citizenship, etc.) and a target demographic for the advertisement as indicated by the advertisement control information. For example, control server 214 may select an advertisement to add to the content that has a target demographic that matches the demographic of the user of user device 218.

Additionally, or alternatively, control server 214 may determine an advertisement to add to the content based on the content to which the advertisement is to be added and a target content for the advertisement as indicated by the advertisement control information. For example, control server 214 may select an advertisement to add to the content that has a target content that matches the content.

Additionally, or alternatively, control server 214 may determine an advertisement to add to the content based on payment information associated with the advertisement as indicated by the advertisement control information. For example, control server 214 may select an advertisement associated with a QoS cost and/or a cost per click that satisfies a threshold level.

In some implementations, control server 214 may determine an advertisement to add to the content by sending user information about the user to advertisement server 220. Advertisement server 220 may receive the user information and select an advertisement based on the user information. Advertisement server 220 may send the selected advertisement to control server 214 and control server 214 may receive the selected advertisement.

Various factors have been discussed that may be the basis for determining the advertisement to add to the content. Control server 214 may determine the advertisement based on these factors individually or a combination of these factors. In some implementations, a score may be generated for each factor. The scores for each factor may be weighted and combined to determine a total score for each of multiple advertisements. Control server 214 may determine the advertisement based on the total score for each advertisement.

As further shown in FIG. 5, process 500 may include determining a QoS level for the advertisement based on the advertisement control information, the excess capacity of bandwidth, the user information, the QoS conditions, and/or the content (block 550). For example, control server 214 may determine a QoS level for the advertisement.

In some implementations, control server 214 may determine the QoS level by determining how much an advertiser will compensate the operator of operator network 202 for providing the advertisement to user device 218. For example, control server 214 may determine how much the advertiser will compensate the operator of operator network 202 based on payment information, included in the advertisement control information, that is associated with a demographic of the user (as indicated by the user information) and/or associated with the content to be provided to user device 218. For instance, the payment information may indicate that the advertiser is willing to compensate a particular cost per click and/or a particular QoS cost for the advertisement.

Furthermore, control server 214 may identify a QoS condition based on the excess capacity of bandwidth. For example, control server 214 may determine cost thresholds (e.g., a cost per click threshold and/or a QoS cost threshold) for different levels of QoS based on the excess capacity of bandwidth.

Control server 214 may compare the amount the advertiser is willing to compensate the operator to the cost thresholds and determine a QoS level based on which cost threshold is satisfied. If no cost thresholds are satisfied, control server 214 may determine a QoS level of the content should be used to transmit the advertisement data.

In some implementations, the determined QoS level may be higher than a QoS level for which user device 218 is otherwise entitled. For example, user device 218 may be associated with a subscription with operator network 202 that entitles user device 218 to be provided data (e.g., content, advertisements, etc.) at particular QoS levels. However, control server 214 may determine user device 218 should be provided an advertisement at a QoS level that exceeds these particular QoS levels based on being compensated, or the potential to be compensated, by the advertiser.

In some implementations, control server 214 may determine which advertisement to add to the content based on the determined QoS level. For example, control server 214 may select an advertisement requiring a first QoS (e.g., an image) based on a first QoS level being determined or select an advertisement requiring a second QoS (e.g., a video) based on a second QoS level being determined.

As further shown in FIG. 5, process 500 may include adding advertisement data for the advertisement, at the determined QoS level, to the content (block 560). For example, control server 214 may add the advertisement data to the content.

Control server 214 may add the advertisement to the content by instructing PCRF server 216 to create a bearer for a QoS class indicator (QCI) associated with the determined QoS level. The bearer may be a traffic separation element that enables differentiated treatment of traffic with different QCIs and provides a logical path between PGW 210 and user device 218 for traffic with a respective QCI. PCRF server 216 may create the bearer based on the instruction from control server 214.

In some implementations, control server 214 may parse existing advertisement content included in the content and add the advertisement data, associated with the determined advertisement, to the content. For example, control server 214 may identify the existing advertisement content included in the content, remove the existing advertisement content, and add the advertisement data to the content so as to be presented where the removed advertisement content would have been presented. Additionally, or alternatively, control server 214 may add the advertisement data to the content in such a way that the advertisement will be presented in addition to the content (e.g., a pop-up advertisement, in a frame within a browser window, in a frame adjacent to an application frame, etc.).

In some implementations, the advertisement data may be marked with a higher differentiated services code point (DSCP) and/or a higher QCI than a DSCP and/or a higher QCI than the content is marked. The DSCP and/or the QCI may indicate a bearer that should be used to transmit the content and/or the advertisement data to user device 218.

As further shown in FIG. 5, process 500 may include providing the content with the added advertisement to user device 218 (block 570). For example, control server 214 may provide the content with the added advertisement to user device 218 via PGW 210, SGW 206, and base station 204. The advertisement data may be transmitted using a bearer associated with the determined QoS level based on the DSCP/QCI used to mark the advertisement data. Additionally, or alternatively, the content may be transmitted using a bearer associated with a QoS level of the content. The QoS level of the content may be determined based on a content requirement, a subscription user device 218 has with operator network 202, and/or policies stored by PCRF server 216. In some implementations, the bearer used to transmit the advertisement data (e.g. a bearer associated with a high QoS) may be different than the bearer used to transmit the content data (e.g., a bearer associated with a low QoS).

User device 218 may receive the content with the added advertisement and present the content and the advertisement to the user. In some implementations, operator network 202 may monitor the user's interaction with user device 218 and/or operator network 202 to determine if the user clicks on the advertisement. Operator network 202 may bill the advertiser based on whether the user clicks on the advertisement and/or for providing the advertisement at the adjusted QoS level to user device 218.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Moreover, in some implementations, control server 214 may also make the advertisement more appealing to a user by compensating a user (e.g., paying the user, providing the user with credits that may be used to upgrade service, etc.) for clicking on or watching the advertisement. In such a case, the advertisement may be added to the content with an indicator notifying the user that the user will be compensated for clicking on or watching the advertisement. In some implementations, control server 214 may determine which advertisements a user will be compensated for and/or how much a user will be compensated based on the advertisement control information, the user information, and/or the content.

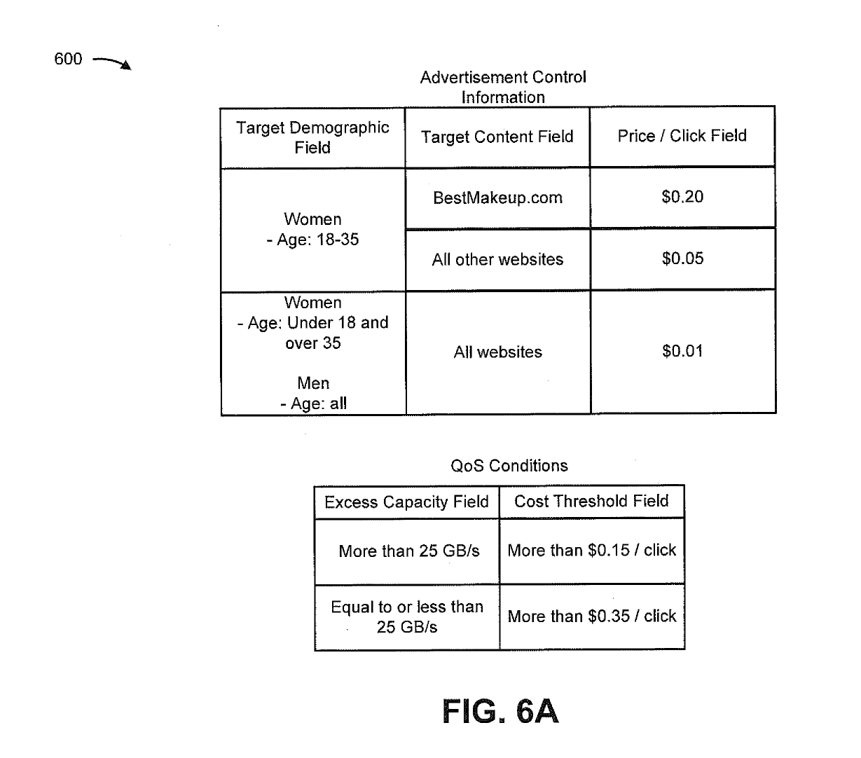

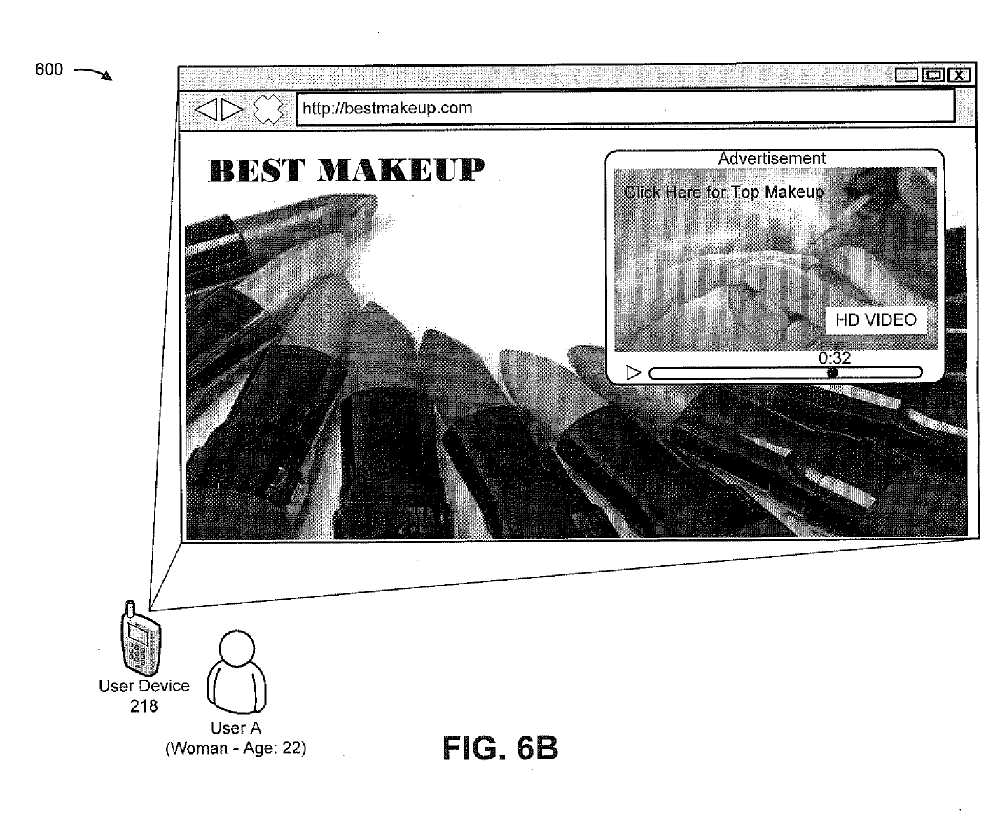

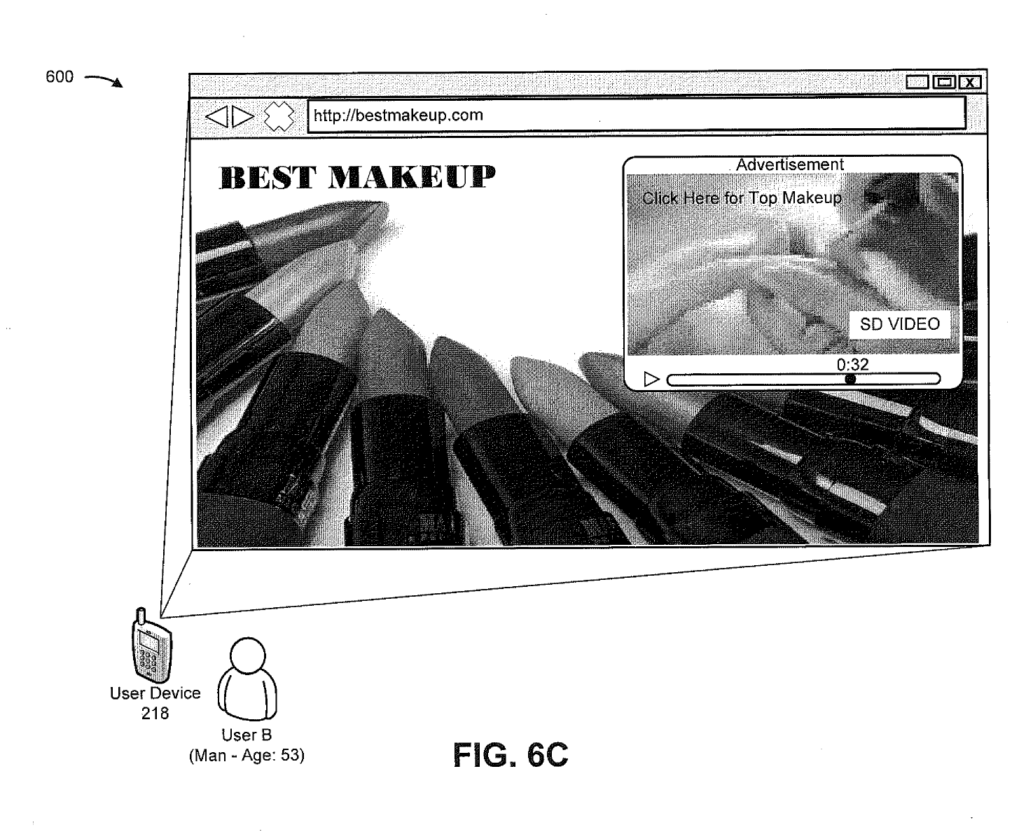

FIGS. 6A-6C are diagrams of an example implementation 600 relating to example processes 400 and 500 shown in FIGS. 4 and 5. FIGS. 6A-6C show an example of preparing to provide an advertisement with an adjusted QoS and providing the advertisement with the adjusted QoS.

In FIG. 6A, assume a company named Top Makeup and an operator of operator network 202 have an agreement for operator network 202 to provide advertisements to user device 218. Further, assume Top Makeup uses advertisement server 220 to send advertisement control information to control server 214 and that control server 214 receives the advertisement control information.

As shown in FIG. 6A, the advertisement control information may include a target demographic field, a target content field, and a price per click field. The target demographic field may indicate demographics that the Top Makeup desires to target with an advertisement. For example, as shown in FIG. 6A, the target demographic field may indicate a demographic of women aged 18-35 and a demographic of everyone else (e.g., women under 18, women over 35, and all men). The target content field may indicate content to which Top Makeup desires to add the advertisement. For example, the target content field may indicate a website (e.g., BestMakeup.com) to which Top Makeup desires to add the advertisement. The price per click field may indicate an amount of money Top Makeup will pay each time a user clicks on the advertisement provided by operator network 202.

For example, the advertisement control information may indicate that Top Makeup will pay $0.20 each time a woman between the ages of 18 and 25 clicks on a Top Makeup advertisement added to BestMakeup.com. The advertisement control information may indicate that Top Makeup will pay $0.05 each time a woman between the ages of 18 and 25 clicks on a Top Makeup advertisement added to any other website beside BestMakeup.com. On the other hand, the advertisement control information may indicate that Top Makeup will pay $0.01 any other time a user clicks on a Top Makeup advertisement.

As further shown in FIG. 6A, assume control server 214 stores information indicating QoS conditions. For example, if there is more than 25 GB/s of unused bandwidth, a QoS level of an advertisement may be increased if the cost per click is greater than $0.15. If there is equal to or less than 25 GB/s of unused bandwidth, then a QoS level of an advertisement may be increased if the cost per click is greater than $0.35.

In FIG. 6B, assume user A is a 22 year old woman and uses user device 218 to send a request for BestMakeup.com via operator network 202 at a time there is 50 GB/s of unused bandwidth in operator network 202. Control server 214 may determine that an advertisement for Top Makeup should be added to BestMakeup.com when the website is provided to user device 218. Control server 214 may also determine that Top Makeup will pay $0.20 if user A clicks on the advertisement based on the advertisement control information. Thus, control server 214 may determine that the amount Top Makeup is willing to pay (e.g., $0.20 per click) is greater than the cost threshold (e.g., $0.15 per click) when there is more than 25 GB/s of bandwidth available. Accordingly, control server 214 may determine to increase the QoS level of the advertisement to a level that is capable of playing high definition (HD) video in the advertisement.

Control server 214 may add the advertisement with HD video to the content of BestMakeup.com and provide the advertisement and the content from BestMakeup.com to user device 218.

In FIG. 6C, assume user B is a 53 year old man and uses user device 218 to send a request for BestMakeup.com via operator network 202 at a time there is 50 GB/s of unused bandwidth in operator network 202. Control server 214 may determine that an advertisement for Top Makeup should be added to BestMakeup.com when the website is provided to user device 218. Control server 214 may also determine that Top Makeup will pay $0.01 if user B clicks on the advertisement based on the advertisement control information. Thus, control server 214 may determine that the amount Top Makeup is willing to pay (e.g., $0.01 per click) is less than the cost threshold (e.g., $0.15 per click) when there is more than 25 GB/s of bandwidth available. Accordingly, control server 214 may determine not to increase the QoS level of the advertisement to a level that is capable of playing high definition (HD) video in the advertisement, and may keep a QoS level of the advertisement the same as the QoS level of the content for BestMakeup.com, which may only be capable of playing standard definition (SD) video.

Control server 214 may add the advertisement with SD video to the content of BestMakeup.com and provide the advertisement and the content from BestMakeup.com to user device 218.

As indicated above, FIGS. 6A-6C are provided merely as an example. Other examples are possible and may differ from what was described with regard to FIGS. 6A-6C.

Implementations described herein may adjust a QoS level of an advertisement provided to a user device based on user analytics. For example, a QoS level of an advertisement provided to a user device may be adjusted based on a demographic of a user of the user device and a target demographic for the advertisement. Thus, in some implementations, advertisements may be effectively provided to a target audience.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. One or more devices, comprising:
one or more processors to:
store advertisement control information for an advertisement,
the advertisement control information indicating a target demographic for the advertisement;
receive the advertisement to be provided to a user device via an operator network;
receive user information that indicates a demographic of a user of the user device;
determine a quality of service level with which to provide the advertisement to the user device,
the quality of service level being determined based on the target demographic and the demographic of the user; and
provide the advertisement to the user device, via the operator network, at the determined quality of service level.

2. The one or more devices of claim 1, where the one or more processors are further to:
receive content to be provided to the user device;
add the advertisement to the content to be provided to the user device; and
where the one or more processors, when providing the advertisement to the user device, are further to:
provide the content with the added advertisement to the user device,
the advertisement being provided at the determined quality of service level.

3. The one or more devices of claim 2, where the advertisement control information indicates a target content to which to add the advertisement, and
where the one or more processors, when determining the quality of service level, are further to:
determine the quality of service level based on the target content and the content to be provided to the user device.

4. The one or more devices of claim 2, where the one or more processors are further to:
determine the advertisement to provide to the user device from among a plurality of advertisements based on the content.

5. The one or more devices of claim 1, where the one or more processors are further to:
determine the advertisement to provide to the user device from among a plurality of advertisements based on the determined quality of service level.

6. The one or more devices of claim 1, where the one or more processors are further to:
determine the advertisement to provide to the user device from among a plurality of advertisements based on the target demographic and the demographic of the user.

7. The one or more devices of claim 1, where the advertisement control information indicates an amount of compensation associated with the advertisement; and
where the one or more processors, when determining the quality of service level, are further to:
determine the quality of service level based on the amount of compensation.

8. A computer-readable medium storing instructions, the instructions comprising:
one or more instructions that, when executed by one or more processors, cause the one or more processors to:
receive advertisement control information associated with an advertisement,
the advertisement control information indicating a target demographic for the advertisement;
receive the advertisement to be provided to a user device via an operator network;
receive user information that identifies a demographic of a user of the user device;
determine a quality of service level with which to provide the advertisement to the user device,
the quality of service level being determined based on whether the demographic of the user is included in the target demographic; and
send the advertisement to the user device, via the operator network, at the determined quality of service level.

9. The computer-readable medium of claim 8, where the one or more instructions, when executed by the one or more processors, further cause the one or more processors to:
determine an excess capacity of bandwidth in the operator network; and
where the one or more instructions, that cause the one or more processors to determine the quality of service level, further cause the one or more processors to:
determine the quality of service level based on the excess capacity of bandwidth in the operator network.

10. The computer-readable medium of claim 9, where the advertisement control information includes payment information that indicates an amount of compensation associated with the advertisement,
where the one or more instructions, that cause the one or more processors to determine the quality of service level, further cause the one or more processors to:
determine the quality of service level based on whether the amount of compensation associated with the advertisement satisfies a threshold amount of compensation associated with the excess capacity of bandwidth in the operator network.

11. The computer-readable medium of claim 8, where the quality of service level is a first quality of service level, and
where the one or more instructions, when executed by the one or more processors, further cause the one or more processors to:
receive content to be provided to the user device;
add the advertisement to the content;
determine a second quality of service level to provide the content to the user device; and
provide the content to the user device at the second quality of service level,
the second quality of service level being different than the first quality of service level.

12. The computer-readable medium of claim 11, where the first quality of service level used to provide the advertisement to the user device is higher than the second quality of service level used to provide the content to the user device.

13. The computer-readable medium of claim 8, where the determined quality of service level exceeds an authorized quality of service level permitted by a subscription with the operator network associated with the user device.

14. The computer-readable medium of claim 8, where the one or more instructions, when executed by the one or more processors, further cause the one or more processors to:
receive a content to be provided to the user device,
add the advertisement to the content to be presented in a frame adjacent to the content; and
provide the content with the added advertisement to the user device for presentation.

15. A method, comprising:
storing, by one or more devices, advertisement control information for an advertisement,
the advertisement control information indicating a target demographic for the advertisement;
receiving, by the one or more devices, the advertisement to be provided to a user device via an operator network;
receiving, by the one or more devices, user information that indicates a demographic of a user of the user device;
determining, by the one or more devices, a quality of service level with which to provide the advertisement to the user device,
the quality of service level being determined based on the target demographic and the demographic of the user; and
providing, by the one or more devices, the advertisement to the user device, via the operator network, at the determined quality of service level.

16. The method of claim 15, where the advertisement control information indicates an amount to be compensated each time the user clicks on the advertisement, and
where determining the quality of service level includes determining the quality of service level further based on the amount to be compensated each time the user clicks on the advertisement.

17. The method of claim 15, where the advertisement control information indicates an amount to be compensated for providing the advertisement at an adjusted quality of service level, and
where determining the quality of service level includes determining the quality of service level based on the amount to be compensated for providing the advertisement at the adjusted quality of service level.

18. The method of claim 15, further comprising:
receiving content with which the advertisement is to be presented to the user device; and
where providing the advertisement to the user device includes providing the advertisement to the user device via a different bearer than the content is provided to the user device.

19. The method of claim 15, further comprising:
receiving content with which the advertisement is to be presented to the user device;
determining an excess capacity of bandwidth on the operator network; and
where determining the quality of service level includes determining the quality of service level based on the content, the advertisement control information, the excess capacity of bandwidth on the operator network, and the user information.

20. The method of claim 15, further comprising:
determining the advertisement to provide to the user device from among a plurality of advertisements based on the target demographic and the demographic of the user.
